(19) United States
(12) Patent Application Publication
(10) Pub. No.: US 2005/0246633 A1
(43) Pub. Date: Nov. 3, 2005

(54) Printing system

(75) Inventors: Kazuhito Gassho, Nagano-ken (JP); Noriyuki Nagai, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/934,733

(22) Filed: Sep. 7, 2004

(30) Foreign Application Priority Data
Sep. 8, 2003 (JP) 2003-315516

(51) Int. Cl. G06F 17/24

(52) U.S. Cl. 715/527

(57) ABSTRACT

In a printing system in which a plurality of terminal devices are connected to a printer, conflicts among multiple setting instructions directed to the printing device are avoided. A terminal device 200[1] sends a print job and setting instructions indicating print density, printing paper, and so on to a printer 100. During access to printer 100, terminal device 200[1] issues “setting disabled notification” to other terminal devices 200[2], 200[3]. When printing with printer 100 is finished, terminal device 200[1] issues “use enabled notification” to other terminal devices 200[2], 200[3]. Terminal devices 200[2], 200[3], after receiving setting disabled notification, refrain from accessing printer 100 until use enabled notification is received. By so doing, printing can be executed while avoiding conflicts among setting instructions among a plurality of terminal devices.

### BACKGROUND OF THE INVENTION

1. Field of the Invention

The present invention relates to a control technology for a printing device which is accessible simultaneously by multiple computers or other devices, whereby competing instructions to the printing device by these multiple devices may be avoided.

2. Description of the Related Art

In recent years, LANs (local area networks) have become widespread, and it has become increasingly common for a networked printer to be shared by multiple computers (hereinafter, client computers) connected to the same network. Each client computer carries out printing by sending a print job to the printer. During printing, it is possible for a client computer to remotely make printer operation settings, such as density during printing, switching between double-sided and single-sided printing, and so on. Such operation settings also can be made by controlling a settings panel provided on the printer.

With a printer that can be accessed by multiple client computers, there is always the possibility that operation settings made for the printer by different client computers can compete. For example, where operation settings made by a number of client computers conflict with one another, there is a risk that the printer will not be set to the intended status, or that it will not be possible to make settings at all. Such conflicts can also occur between settings made from a client computer and those made from the settings panel. A technology for avoiding such conflicts is disclosed, for example, in Japanese Pat. No. 3347521. According to this technology, the printer monitors setting control status from external devices such as client computers and the printer settings panel, and in the event that setting controls are being made by any one external device, refuses requests to set controls from other external devices.

In the conventional technology described above, since the printer carries out the control needed to avoid conflicts in operation settings, a relatively great control burden is placed on the printer. Additionally, since it requires that such new functionality be incorporated into the printer, there is a practical limitation in that conflicts in operation settings will not be avoidable with printers lacking such functionality. With the foregoing in view, it is therefore an object of the present invention to provide novel technology for avoiding conflicts in operation settings.

### SUMMARY OF THE INVENTION

In order to address the aforementioned problems at least in part, in the present invention, an arrangement such as the following is employed. A plurality of setting devices for setting operations of a printing device on the basis of user control can be arranged as setting devices used in a printing system connected to the printing device. Setting devices may be computers connected to the printing device via the network, a settings panel provided on the printing device, or any of various other kinds of devices having a setting instruction input module enabling a user to set the operation of the printing device.

The setting device in the present invention inputs from the printing device or from another setting device a notification usable for controlling whether setting of the printing device is currently enabled or disabled, and on the basis of this notification controls whether output of a setting request to perform setting of the printing device is currently enabled or disabled. That is, in the present invention, control is executed by each setting device so as to avoid conflicting settings. By so doing, the control burden placed on the printing device in relation to control in order to avoid conflicts can be reduced or eliminated entirely. Also, conflicting settings can be avoided even where a printing device is not equipped with control functionality for avoiding conflicting settings.

Enabling/disabling of setting requests may be realized in a number of ways. For example, where it is determined that the current status does not permit operation settings to be made for a printing device, the setting device may deny a setting instruction from the user. Alternatively, having received a setting instruction from the user, output thereof to the printing device may be suspended.

The aforementioned notification may include a setting disabled notification, signifying that operation settings cannot be made by the setting device. In the sense of avoiding conflicting settings, the setting disabled notification may take the form of notification indicating that setting of the printing device by a certain setting device is currently in effect, for example. Upon receiving such setting disabled notification, the setting device subsequently prohibits output of setting requests until a predetermined timing is reached. By so doing, by not performing output of setting requests by setting devices in the event that setting by one particular setting device is currently in effect, it is possible to avoid setting conflicts. Predetermined timing refers, for example, to a point in time after a predetermined time interval has elapsed after receiving a setting disabled notification; or to a point in time after receiving a setting disabled notification, at which another notification canceling the previous notification is received.

Notification in the present invention may include a use enabled notification indicating that operation setting by a setting device is enabled, i.e. that use of the printing device is enabled. A setting device, in the event of receiving such use enabled notification, may perform control to permit the output of a setting request only until a predetermined timing is subsequently reached. By so doing, operation settings are made only when there has been notification that the printing device is in a use enabled state, so that the likelihood of conflicts can be reduced.

According to the present invention, both the setting disabled notification and use enabled notification described above may be used. By so doing, it becomes possible to exercise control such that the output of a setting request is enabled for a period coming after a use enabled notification is received, until a setting disabled notification is received.

Notifications used in the present invention may be issued by a printing device, or issued by a setting device. As an example of being issued by a setting device, in the event that, for example, a setting device has output a setting request to the printing device, the setting device could output the setting disabled notification to other setting devices. This corresponds to an embodiment in which a setting device itself informs other setting devices of the fact that it is making settings to the printing device. Such an embodiment has the advantage that conflict avoidance in the invention can be realized without the printing device being provided with notification functionality. The setting disabled notification may be issued a single time only, at the point in time at which a setting request is output, for example; or may be issued repeatedly during the period for which the setting is enabled. By so doing, in the event that, for example, a setting device is connected to the network after the initial setting disabled notification has been issued, output of a setting request can be prevented by a second or subsequent setting disabled notification, so as to reliably avoid conflicts.

A setting device may additionally issue a use enabled notification to other setting devices, when it finishes using the printing device. This corresponds to an embodiment in which a setting device itself informs other setting devices of the fact that it is finished using the printing device. By so doing, in response to this notification other setting devices are able to quickly use the printing device, which has the advantage that the printing device can be operated efficiently.

The printing device of the present invention may input a setting request from any setting device and set its operation with reference to this input. Further, the printing device can issue notification to each setting device depending on whether or not there is input of a setting request. By having setting disabled notification or use enabled notification be issued by printing device itself, the likelihood of there being issued notification differing from actual status of the printing device is reduced.

Such notification may be issued simultaneously to a plurality of setting devices by means of broadcast or multicast, or issued to each setting device by means of unicast. When use enabled notification is issued by a printing device, to a plurality of setting devices, it is preferable to notify them sequentially one at a time by means of unicast. By so doing, the likelihood of simultaneous access of the printing device by a plurality of setting devices once use enabled notification has been received can be reduced, so that conflicts may be avoided more reliably. In order to enable unicast notification, in preferred practice, address information for each setting device will be administered in advance.

Notification by a printing device may be issued only once, such as at the point in time that a setting request is input; in preferred practice, however, notification will be issued repeatedly regardless of change in a status of the setting request input. By so doing, notification may be transmitted more reliably to setting devices.

The present invention may be implemented in all setting devices connected to a printing device, or implemented only in some setting devices. For example, control different from that of other setting devices may be implemented for the setting panel, so as to permit settings to be modified from the setting panel even during setting by the nother setting device.

The invention need not be furnished with all of the features described hereinabove, it being possible to omit or combine some of them as appropriate. The invention may also take various other aspects such as a control method for control for conflict avoidance as described above in the setting devices and printing device; a computer program for realizing such control; a computer-readable storage medium having such a computer program recorded thereon; or a data signal containing such a computer program and embodied in a carrier wave. Here, storage media include flexible disks, CD-ROM, magnetooptical disks, IC cared, ROM cartridges, punch cards, printed matter imprinted with symbols such as bar codes, computer internal storage devices (RAM, ROM or other memory), and external storage devices, and various other computer-readable storage media.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is an illustration showing a simplified arrangement of a printing system in a first embodiment;

FIG. 2 is a flowchart of the printing process;

FIG. 3 is a flowchart of the setting control process;

FIG. 4 is a flowchart of the setting control process in a first variation;

FIG. 5 is a flowchart of the printing process in a second variation;

FIG. 6 is an illustration showing a simplified arrangement of a printing system in a second embodiment; and

FIG. 7 is a flowchart of the setting control process in a variation of the second embodiment.

### DETAILED DESCRIPTION OF THE PREFERRED EMBODIMENTS

The embodiments of the invention will be described in the following order.
A. First embodiment:
A1. System Arrangement:
A2. Printing Process:
A3. Setting Control Process:
A4: Variation 1:
A5: Variation 2:
B1. Second embodiment:
B2: Variation:

### A. First Embodiment

A1. System Arrangement:

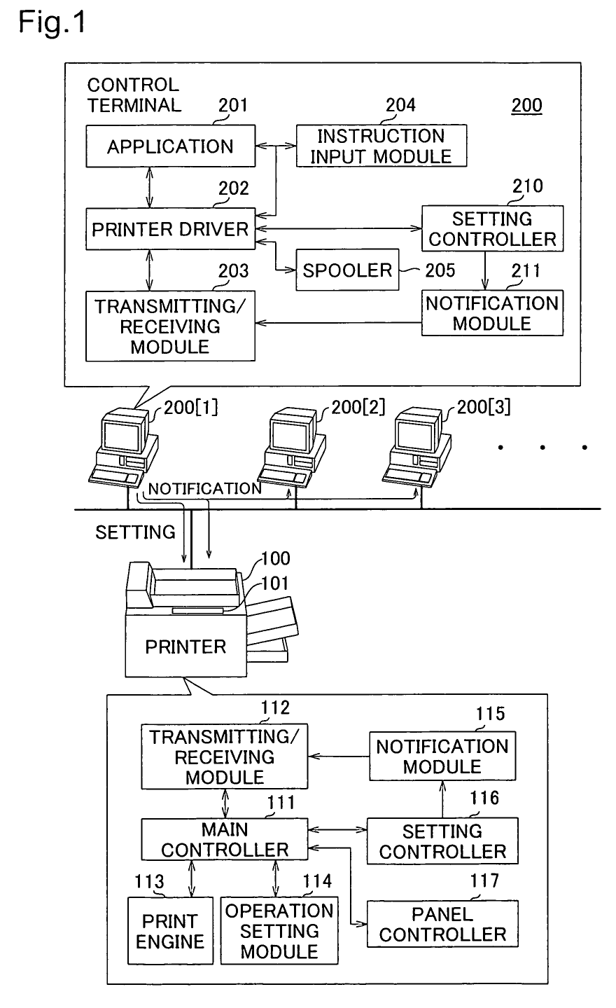

FIG. 1 is an illustration showing a simplified arrangement of a printing system in a first embodiment. This printing system constitutes a printer 100 and a plurality of terminal devices 200 interconnected on a network. The numbers of printers 100 and terminal devices 200 are not limited to those shown in the drawing. For convenience in description, terminal devices 200 are shown distinguished from one another by the symbols 200 [1]-200[3].

Each terminal device 200 is an ordinary personal computer composed of the functional blocks shown in the drawing, by means of software running on an operating system. A transmitting/receiving module 203 performs communication via the network. A printer driver 202 converts text data or image data created by an application program 201 into print data that can be handled by printer 100, and spools it onto a spooler 205. Printer driver 202 also has the function of displaying an interface screen for making operation settings such as print density, double sided/single-sided, paper size, resolution and so on. Terminal device 200 has an instruction input module 204, such as a keyboard and mouse, for control inputs; by controlling these, a user can input a print command, instruct operation settings for the printer, and the like.

A setting control module 210 and a notifying module 211 are provided for the purpose of avoiding conflicting settings for printer 100 among the plurality of terminal devices. Setting control module 210 prohibits access to printer 100 in the event it is decided that another terminal device 200 is accessing printer 100, and permits access to printer 100 when not being accessed by any terminal device 200. Herein, access refers not simply to a period in which communication takes place, but to a period of substantially exclusive use of printer 100. In this embodiment, a setting instruction made by a user directly to the printer 100 is received even when access to the printer 100 has been prohibited. The setting control module 210 carries out control in such a way that during the time that access is prohibited, setting instructions are spooled onto the spooler 205, and are output to the printer 100 at a point in time that access is permitted. Notifying module 211 notifies other terminal devices 200 to the effect that it is accessing the printer 100, in order to restrict access by other terminal devices 200. The setting control module 210 and notifying module 211 may be provided as software separate from the printer driver 202, or incorporated as functions in the printer driver 202.

A control unit internally comprising a CPU, ROM, RAM and so on is disposed within the printer 100, and in accordance with software stored in ROM is composed of the functional blocks shown in the drawing. These functional blocks operate in cooperation under control of a main controller 111. A transmitting/receiving module 112 carries out communication via the network. A panel controller 117 performs control of display contents on a setting panel 101 provided on printer 100 for making operation settings, and also receives control inputs to the setting panel 101. An operation setting module 114 carries out printer 100 operation settings, i.e. settings relating to print density, paper, and so on, in accordance with setting instructions made by operating the setting panel 101, or sent from a terminal device 200. A print engine 113 controls the printing mechanism of printer 100 on the basis of print data received from a terminal device 200, to carry out printing.

A setting control module 116 and a notifying module 115 are provided for the purpose of avoiding conflicting settings for printer 100 between terminal devices 200 and the setting panel 101. The functions thereof are analogous to those of the setting control module 210 and notifying module 211 provided to a terminal device 200. Setting control module 116 and notifying module 115 may be incorporated as new modules in the firmware of printer 100, for example; or their functions may be realized through a board installed in printer 100 for that purpose.

In this embodiment, the setting control module 116 and notifying module 115 may be dispensed with. Where these are dispensed with, conflicting setting instructions between terminal devices 200 and the setting panel 101 will be permitted, it being possible, for example, for a setting instruction from a terminal device 200 to be modified by operating the setting panel 100. However, the processes hereinbelow are described as taking place in a printer 100 equipped with a setting control module 116 and a notifying module 115, as shown in the drawing.

A2. Printing Process:

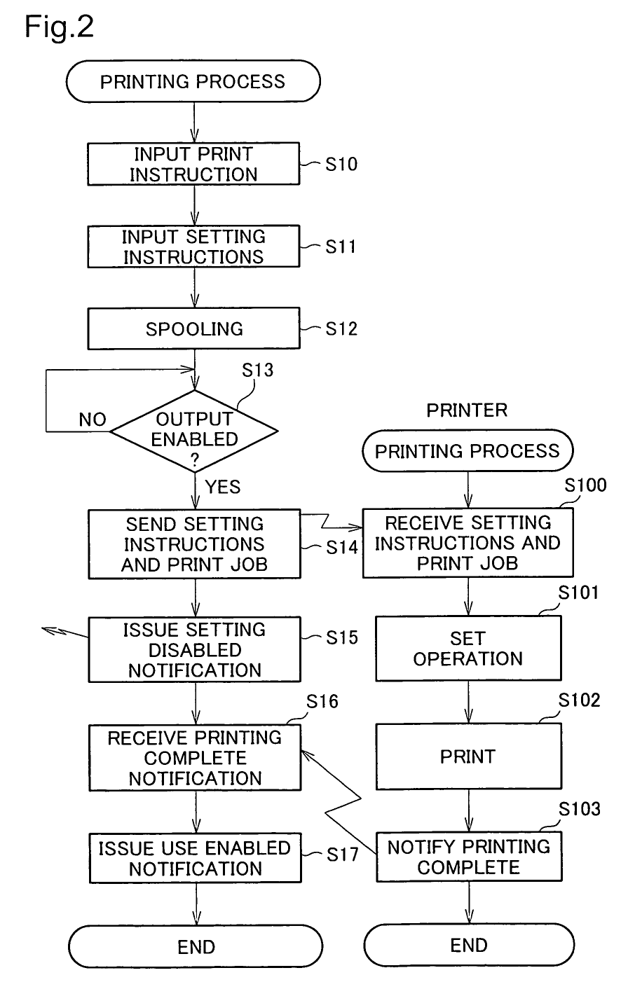

FIG. 2 is a flowchart of the printing process. At left is shown a process executed by terminal device 200[1]; at right is shown a process executed by the control unit of printer 100. Here, for convenience in description, the specifics of the process are described taking the example of terminal device 200[1] in FIG. 1; however, the process would be analogous for the other terminal devices 200[2], 200[3].

When the terminal device receives a print instruction on the basis of user control input (Step S10), the terminal device 200[1] displays an operation settings window for printer 100, and receives setting instructions from the user (Step S11). The terminal device 200[1] then performs spooling (Step S12). Specifically, it uses the printer driver 202 to generate print data, which is spooled onto the spooler. At this time, the setting instructions to the printer 100 are stored as well.

The terminal device 200[1] waits in this state until output of the setting instructions and print data to the printer 100 is allowed (Step S13). For example, output would be prohibited in the event that printing is being carried out under instructions from another terminal device 200[2], 200[3], or printer 100 settings are being made from the setting panel 101. Output would be allowed in the event that printer 100 is not being controlled by any of these devices.

When output is allowed, terminal device 200[1] sends the setting instructions and print job to the printer 100 (Step S14). Subsequently, in order to restrict access to the printer 100 by the other terminal devices 200[2], 200[3] and setting panel 101, it issues a “setting disabled notification” (Step S15). No particular format is required for the setting disabled notification; any message by which the content of the notification can be interpreted by each terminal device 200 is acceptable. This notification can be issued by means of broadcasting to all recipients, i.e. other terminal devices 200[2], 200[3] and a printer 100 having a setting panel 101, or by means of multicasting to some of these recipients.

Meanwhile, the printer 100 receives the setting instructions and print job from terminal device 200[1] (Step S100), and on the basis of the setting instructions performs operation settings (Step S101) and executes printing (Step S102). Upon completion of printing, it issues a printing completed notification to terminal device 200[1] (Step S103).

Upon receiving the printing completed notification, terminal device 200[1] issues a use enabled notification (Step S17) in order to permit access to printer 100 by the other terminal devices 200[2], 200[3] and the setting panel 101. This notification can be issued by broadcast or multicast. In the processes described above, terminal device 200 accesses printer 100 only the event that output is enabled, thereby avoiding conflicts among instructions from different terminal devices 200 and the setting panel 101.

A3. Setting Control Process:

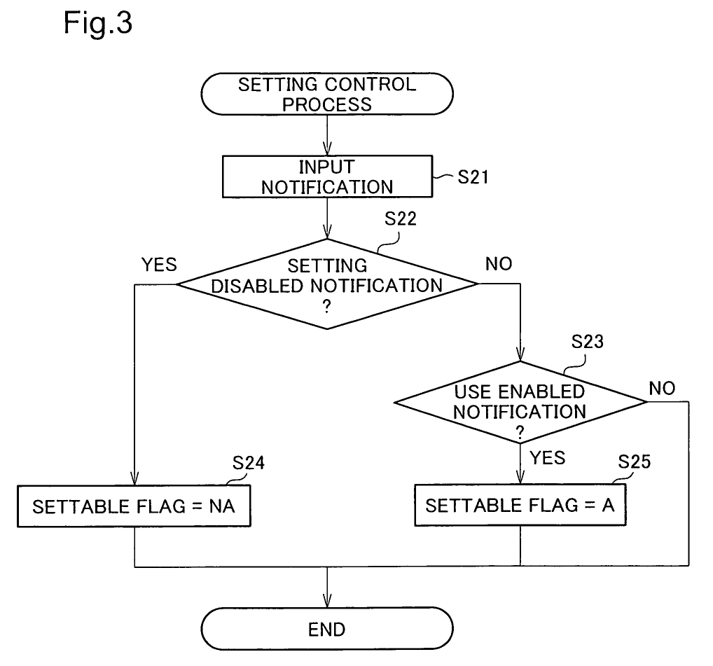

FIG. 3 is a flowchart of the setting control process. The process is one executed by terminal device 200 separately from the printing process, and represents a process for controlling whether output is enabled in Step S13 of FIG. 2. Regardless of whether a printing process is being executed or not, terminal device 200[1] receives notification sent via the network (Step S21). This notification is issued by the other terminal devices 200[2], 200[3] or the setting panel 101.

In the event that a setting disabled notification is input (Step S22), terminal device 200[1] stores in a “settable flag” a value of “NA (Not Available)” indicating that output to printer 100 is disabled (Step S24). Where a use enabled notification is input instead of a setting disabled notification (Step S22, S23), a value of “A (Available)” indicating that printer 100 is useable is stored in the “settable flag” (Step S25). If the notification is neither of the two, content of the settable flag maintains the prior value. In the printing process (Step S13 of FIG. 2), terminal device 200[1], when the settable flag set in this manner is “NA”, it is possible to decide that output is prohibited.

By means of this process, when terminal device 200[1] issues a setting disabled notification (Step S15 of FIG. 2) during access of printer 100, the settable flag will be set to “NA” for the other terminal devices 200[2], 200[3] and the setting panel 101. Accordingly, as described in the printing process (Step S13 of FIG. 2), output of setting instructions and print jobs to the printer 100 from these devices is prohibited. When terminal device 200[1] finishes printing and issues a use enabled notification (Step S17 of FIG. 2), the settable flag will be set to “A” for the other terminal devices 200[2], 200[3]. Accordingly, as described in the printing process (Step S13 of FIG. 2), output of setting instructions and print jobs to the printer 100 from these devices is now permitted. According to the printing system of this embodiment, by having a terminal device which is accessing printer 100 issue a setting disabled notification, conflicts among a plurality of instructions to the printer 100 can be avoided.

A4: Variation 1:

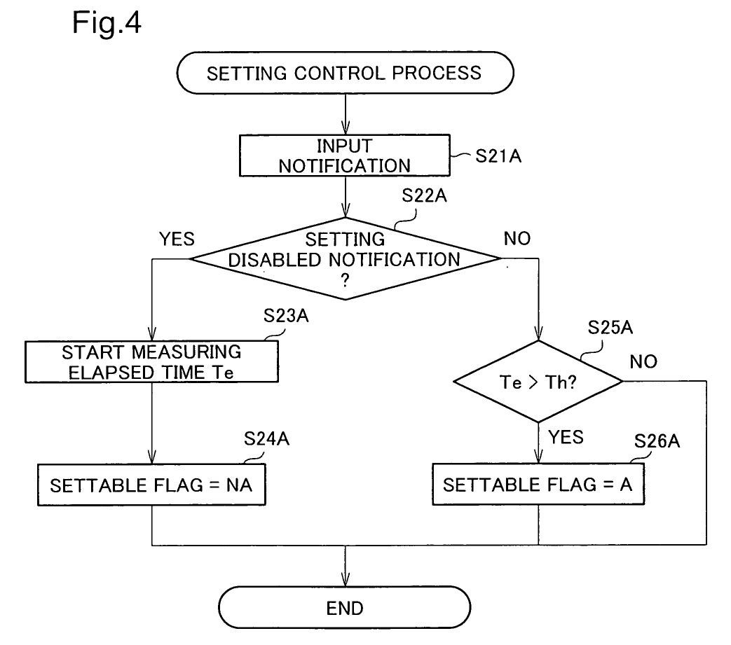

FIG. 4 is a flowchart of the setting control process in a first variation. In the first embodiment, enabling/disabling of output to printer 100 is controlled using a use enabled notification in conjunction with a setting disabled notification (see Step S23 of FIG. 3). In Variation 1 on the other hand, there is shown an example in which enabling/disabling of output to printer 100 is controlled on the basis of time elapsed since receiving setting disabled notification, rather than on the basis of a use enabled notification. Terminal device 200[1], in the event that a setting disabled notification is input (Steps S21A, S22A) begins measuring elapsed time Te (Step S23A), as well as storing “NA” in the settable flag (Step S24A). In the event that a setting disabled notification is not received (Step S22A), where elapsed time Te has passed a predetermined threshold Th (Step S25A), “A” is stored in the settable flag (Step S26A). Where elapsed time has not yet reached threshold Th, the settable flag holds the previous value.

By so doing, it is possible to reduce the likelihood of conflict among multiple instructions, even without a “use enabled notification.” In the process of Variation 1, the printing completed notification from printer 100 to terminal devices 200 (Steps S103, S16 of FIG. 2) can be dispensed with, which has the advantage that the process can be made simpler.

A5. Variation 2

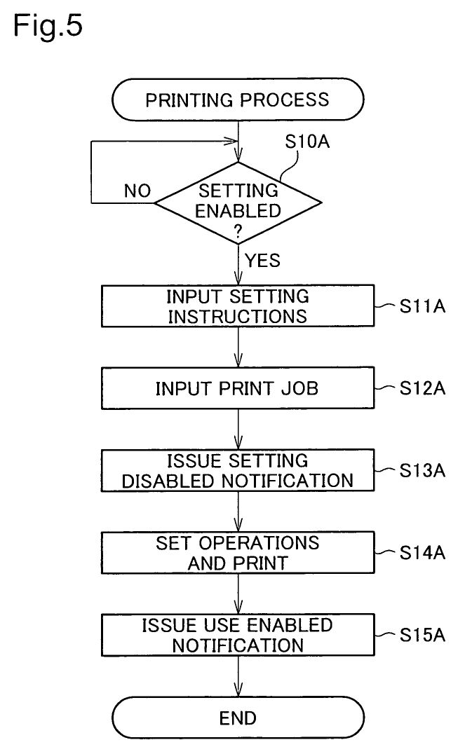

FIG. 5 is a flowchart of the printing process in a second variation. Whereas in the first embodiment (FIG. 2), an example of a process in a terminal device 200 was shown, in Variation 2 there is shown an exemplary setting process using the setting panel 101. This process is executed by the control unit of printer 100. When the process starts, the control unit determines whether setting from the setting panel 101 is permitted (Step S10A). This determination can be made as in the first embodiment, by referring to the settable flag administered by the control unit. In the event that the settable flag is “NA”, since setting is not permitted, operation of the setting panel 101 is not accepted until the flag value becomes “A”.

When setting is permitted (Step S10A), the control unit accepts input of setting instructions from the setting panel 101 (Step S11A) and accepts input of a print job (Step S12A). Print jobs may be permitted to be received only from the terminal device used by the operator of the setting panel 101, or permitted to be received from any terminal device. In the former case, the method for identifying the terminal device used by the operator of the setting panel 101 may employ inputting a user ID, terminal ID, or other information, for example.

In the event that any setting instruction and print job are accepted in this manner, in order to avoid conflicts of instructions, the control unit issues a setting disabled notification (Step S13A). This instruction can be broadcast or multicast. Subsequently, after operation settings of the printer 100 have been made and printing executed (Step S14A), a use enabled notification is issued (Step S15A), and the printing process concludes. By so doing, conflicts between control inputs to the setting panel 101 and instructions from terminal devices can be avoided.

### B1. Second Embodiment

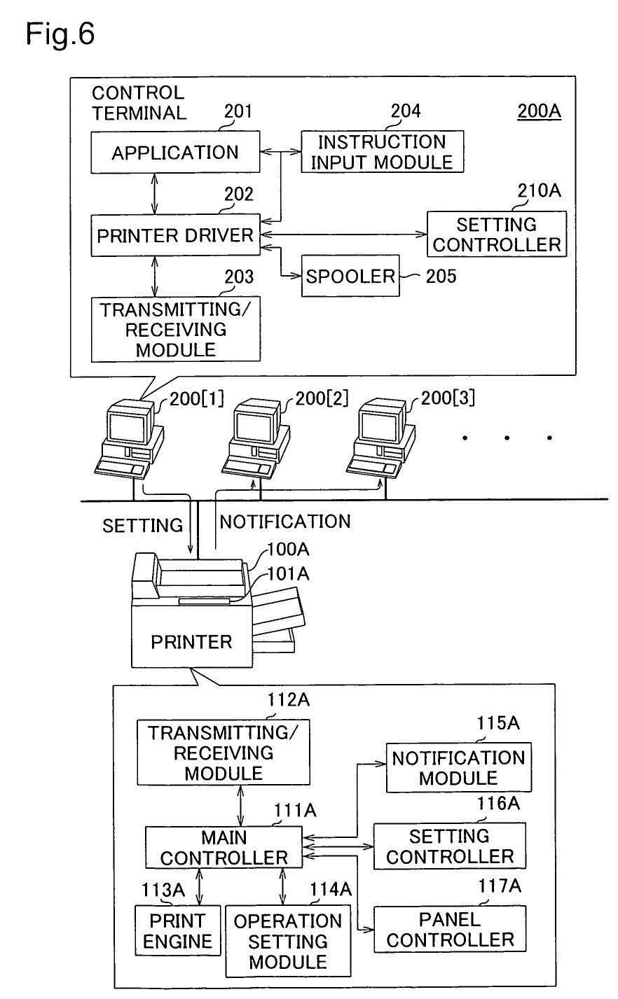

FIG. 6 is an illustration showing a simplified arrangement of a printing system in a second embodiment. In the second embodiment, notifications are carried out by the printer 100A. As in the first embodiment, a setting control module 210A is provided in terminal device 200A, but the notifying module is dispensed with. Also, as in the first embodiment, printer 100A is provided with various functional blocks (main controller 111A panel controller 117A). However, notifying module 115A operates under control of the main controller 111A, irrespective of instructions from the setting controller 116A. By means of this arrangement, in the second embodiment, it is possible for notifying module 115A to issue notification not only in cases of control inputs being made to setting panel 101A, but also in cases where operating settings are made by means of instructions from a terminal device 200.

The printing in the second embodiment is carried out by a process analogous to that of the first embodiment (FIG. 2). Here, print disabled notification and use enabled notification in FIG. 2 will be issued by the printer 100A. By means of this printing process as well, it is possible to execute printing while avoiding conflicts among multiple instructions. According to the second embodiment, since the printer 100A carries out notification, it is possible to avoid situations in which a notification differs from actual conditions of the printer 100A. For example, the likelihood of a use enabled notification being issued despite the printer 100A being accessed by any of the terminal devices 200, or of a setting disabled notification being issued despite the printer 100A being in a useable state, may be reduced.

B2. Variation:

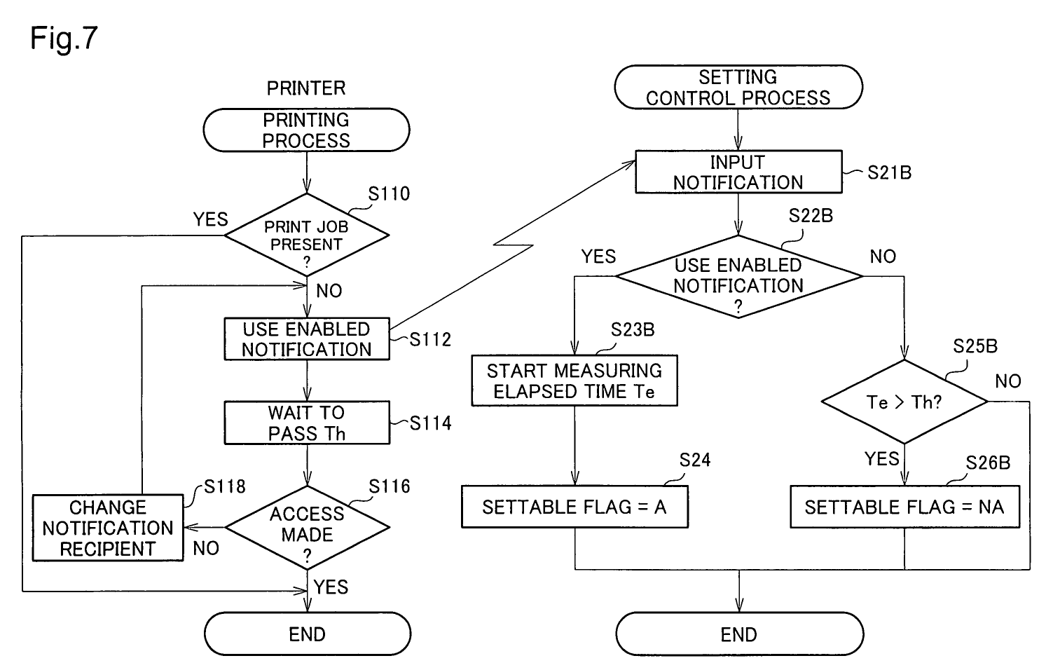

FIG. 7 is a flowchart of the setting control process in a variation of the second embodiment. At left is shown a process executed by printer 100A; at right is shown a process executed by each terminal device 200. In this Variation, there is shown in example in which the setting disabled notification is omitted, with access to the printer 100A being enabled or disabled on the basis of time elapsed after a use enabled notification is received.

Printer 100A determines whether there is a print job to be printed (Step S110), and in the event that there is no print job issues a use enabled notification (Step S112). This notification is issued sequentially to each terminal device in a predetermined order. Here, it is initially issued to terminal device 200[1]. In this state, printer 100A waits for access from terminal device 200[1] until a threshold value Th is exceeded (Step S114); in the event that no access is made (Step S116), the notification recipient is changed to the next notification recipient, for example, terminal device 200[2] (Step S118), and a use enabled notification is issued (Step S112). Printer 100A executes this process repeatedly until being accessed by a terminal device.

In a terminal device, on the other hand, when a use enabled notification is input (Step S21B, S22B), measurement of elapsed time Te is begun (Step S23B), and “A” is stored in the settable flag (Step S24B). At this timing, if a print instruction is made by the user, terminal device 200 can transmit setting instructions and the print job to printer 100A. On the other hand, if a use enabled notification is not received (Step S22B), at the point in time that elapsed time Te exceeds threshold value Th, the settable flag is set to “NA” (Step S26B). The previous value is held in the settable flag until threshold value Th is exceeded. As described previously, at the point in time that the settable flag is set to “NA”, a use enabled notification is issued to another terminal device by the printer 100A, so in this other terminal device, the settable flag is set to “A.”

According to the process of this Variation, it is possible to avoid conflicts among multiple instructions, even if setting disable notification is omitted. In the Variation, there is given an example wherein a use enabled notification is issued to terminal devices one at a time; however, the likelihood of conflict could be reduced somewhat by broadcast or multicast as well.

While the invention has been shown and described hereinabove through embodiments, the invention is not limited in any way to the particular embodiments herein, and may take various other arrangements without departing from the scope and spirit of the invention. For example, the invention is not limited to printers, but is applicable as well to printing devices of various kinds. The control processes described herein could be executed through software, or executed through hardware. The setting control processed described herein could be combined appropriately, or used selectively depending on various parameters.

The Program product may be realized as many aspects. For example:
(i) Computer readable medium, for example the flexible disks, the optical disk, or the semiconductor memories;
(ii) Data signals, which comprise a computer program and are embodied inside a carrier wave;
(iii) Computer including the computer readable medium, for example the magnetic disks or the semiconductor memories; and
(iv) Computer temporally storing the computer program in the memory through the data transferring means.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

1. Setting device for use in a printing system in which a plurality of setting devices for setting operations of a printing device based on user control are connected to the printing device, the setting device comprising:
a notification input module for inputting from the printing device or from another setting device a notification usable for controlling enabling/disabling of setting the printing device;
a setting instruction input module allowing the user to input operation settings of the printing device; and
a setting control module for outputting a setting request for the settings to the printing device based on the notification.

2. Setting device according to claim 1 wherein
the notification includes a setting disabled notification indicating that operation settings by another setting device among the plurality of setting devices is in effect; and
the setting control module, when receiving such use enabled notification, suspends the output of the setting request until a predetermined timing is reached.

3. Setting device according to claim 1 wherein
the notification includes a use enabled notification indicating that the printing device is useable, and
the setting control module, after receiving the use enabled notification, is able to perform the output of the setting request only until a predetermined timing is reached.

4. Setting device according to claim 1 wherein
the notification includes a setting disabled notification indicating that operation settings by another setting device among the plurality of setting devices is in effect, and a use enabled notification indicating that the printing device is useable; and
the setting control module, after receiving the use enabled notification, is able to perform the output of the setting request only until the setting disabled notification is received.

5. Setting device according to claim 1 wherein
the notification includes a setting disabled notification indicating that setting of the printing device by the setting device is in effect, and
the setting device further comprises a notification controller for issuing a setting disabled notification to the other setting device in response to the output of the setting request to the printing device.

6. Setting device according to claim 5 wherein the notification controller repeatedly issues the setting disabled notification during an interval that the setting by the setting device is in effect.

7. Setting device according to claim 5 wherein the notification includes a use enabled notification indicating that the printing device is useable; and
the notification controller, when use of the printing device by the setting device is finished, issues the use enabled notification.

8. Printing device for use in a printing system in which a plurality of setting devices for setting operations of a printing device on the basis of user control are connected to the printing device, wherein each setting device is able, based on a notification for controlling enabling/disabling of settings, to output a setting request for setting operation of the printing device, the printing device comprises:
a setting input module for inputting the setting request from any of the setting devices;
an operation setting module for setting an operation of the printing device in response to the input; and
a notification controller for issuing to each setting device the notification, depending on whether the setting request is input.

9. Printing device according to claim 8 wherein
the notification controller issues the notification to the plurality of setting devices sequentially one at a time.

10. Printing device according to claim 8 wherein
the notification controller issues the notification repeatedly regardless of change in a status of the setting request input.

11. Control method for use in a printing system in which a plurality of setting devices for setting operations of a printing device based on user control are connected to the printing device, for controlling operation of the setting devices, the method comprising the steps of
inputting from the printing device or from another setting device notification for controlling enabling/disabling of setting the printing device;
receiving operation setting of the printing device by the user; and
outputting a setting request for the settings to the printing device on the basis of the notification.

12. Control method for controlling operation of a printing device in a printing system in which a plurality of setting devices for setting operations of a printing device on the basis of user control are connected to the printing device, wherein
each setting device is able, on the basis of notification for controlling enabling/disabling of settings, to output a setting request for setting operation of the printing device; and
the method comprising the steps of inputting the setting request from any of the setting devices;
setting an operation of the printing device in response to the input; and
issuing to each setting device the notification, depending on whether the setting request is input.

13. Computer program product for use in a printing system in which a plurality of setting devices for setting operations of a printing device on the basis of user control are connected to the printing device, for controlling operation of the setting devices, the computer program product comprising:
a computer-readable storage medium; and
a computer program stored on the computer-readable storage medium;
wherein the computer program includes:
a module for inputting from the printing device or from another setting device notification for controlling enabling/disabling of setting the printing device;
a module for receiving operation setting of the printing device by the user; and
a module for outputting a setting request for the settings to the printing device on the basis of the notification.

14. Computer program product for controlling operation of a printing device in a printing system in which a plurality of setting devices for setting operations of a printing device on the basis of user control are connected to the printing device, wherein
each setting device is able, on the basis of notification for controlling enabling/disabling of settings, to output a setting request for setting operation of the printing device,
the computer program product comprising:
a computer-readable storage medium; and
a computer program stored on the computer-readable storage medium,
wherein the computer program includes:
a module for inputting the setting request from any of the setting devices;
a module for setting an operation of the printing device in response to the input; and
a module for issuing to each setting device the notification, depending on whether the setting request is input.
